(19) United States
(12) Patent Application Publication
(10) Pub. No.: US 2023/0262322 A1
(43) Pub. Date: Aug. 17, 2023

(54) MECHANISM FOR IMPROVING IMAGE CAPTURE OPERATIONS

(71) Applicant: QUALCOMM Incorporated, San Diego, CA (US)

(72) Inventors: Yaoyao HOU, Beijing (CN); Xiaocheng WANG, Beijing (CN); Zhigang TIAN, Beijing (CN)

(21) Appl. No.: 18/040,254

(22) PCT Filed: Oct. 22, 2020
(86) PCT No.: PCT/CN2020/122647

§ 371 Date: Feb. 1, 2023

(51) Int. Cl. H04N 23/60; H04N 5/265; G06T 7/70; G06V 10/25; G06V 10/46; G06V 10/74; G03B 13/36

(52) U.S. Cl. CPC H04N 23/64; H04N 5/265; G06T 7/70; G06V 10/25; G06V 10/46; G06V 10/761; G03B 13/36; G06V 2201/07; G06T 2207/20101; G06T 2207/20104

(57) ABSTRACT

Techniques and systems are provided for improving one or more image capture operations. In some examples, a system detects a user input corresponding to a selection of a location within an image frame. The system determines that the image frame includes an object at least partially within a region of interest of the image frame, the region of interest including the selected location and having a predetermined size or a predetermined shape. The system then adjusts the region of interest based at least in part on the determination and performs one or more image capture operations on image data within the adjusted region of interest.

### FIELD

This application is related to image processing. In some examples, aspects of this application relate to systems, apparatuses, methods, and computer-readable media providing a mechanism for improving image processing and/or image capturing operations (such as auto-focus algorithms and related algorithms) performed on image data within captured image frames.

### BACKGROUND

Cameras can be configured with a variety of image capture and image processing settings to alter the appearance of an image. Some image processing operations are determined and applied before or during capture of the photograph, such as auto-focus, auto-exposure, and auto-white-balance operations. These operations are configured to correct and/or alter one or more regions of an image (for example, to ensure the content of the regions is not blurry, over-exposed, or out-of-focus). The operations may be performed automatically by an image processing system or in response to user input. More advanced and accurate image processing techniques are needed to improve the output of image processing operations.

### SUMMARY

The technologies described herein can be implemented to improve image capture and/or image processing operations. According to at least one example, methods for improving one or more image capture operations in image frames are provided. An example method can include detecting a user input corresponding to a selection of a location within an image frame. The method can also include determining that the image frame includes an object at least partially within a region of interest of the image frame, the region of interest including the selected location and having a predetermined size or a predetermined shape. The predetermined size or the predetermined shape of the region of interest can be adjusted based at least in part on the determination. One or more image capture operations can then be performed on image data within the adjusted region of interest.

In another example, apparatuses are provided for improving one or more image processing operations in image frames. An example apparatus can include memory and one or more processors configured to detect a user input corresponding to a selection of a location within an image frame. The one or more processors can determine that the image frame includes an object at least partially within a region of interest of the image frame, the region of interest including the selected location and having a predetermined size or a predetermined shape. The predetermined size or the predetermined shape of the region of interest can be adjusted based at least in part on the determination. One or more image capture operations can then be performed on image data within the adjusted region of interest.

In another example, an example apparatus can include: means for detecting a user input corresponding to a selection of a location within an image frame; means for determining that the image frame includes an object at least partially within a region of interest of the image frame, the region of interest including the selected location and having a predetermined size or a predetermined shape; means for adjusting the predetermined size or the predetermined shape of the region of interest based at least in part on the determination; and means for performing the one or more image capture operations on image data within the adjusted region of interest.

In another example, non-transitory computer-readable media are provided for improving one or more image processing operations in image frames. An example non-transitory computer-readable medium can store instructions that, when executed by one or more processors, cause the one or more processors to detect a user input corresponding to a selection of a location within an image frame. The instructions can also cause the one or more processors to determine that the image frame includes an object at least partially within a region of interest of the image frame, the region of interest including the selected location and having a predetermined size or a predetermined shape. The predetermined size or the predetermined shape of the region of interest can be adjusted based at least in part on the determination. One or more image capture operations can then be performed on image data within the adjusted region of interest.

In some aspects, the image frame can be received within a preview stream of frames including image frames captured by a camera device while the camera device is in an image capture mode.

In some aspects, determining that the image frame includes the object at least partially within the region of interest of the image frame includes performing an object detection algorithm within the region of interest. In some examples, adjusting the predetermined size or the predetermined shape of the region of interest can include adjusting the predetermined shape of the region of interest based on the object detection algorithm. For example, adjusting the predetermined shape of the region of interest can include determining a bounding box for the object based on the object detection algorithm and setting the region of interest as the bounding box.

In some aspects, adjusting the predetermined size or the predetermined shape of the region of interest can include decreasing the predetermined size of the region of interest along at least one axis, increasing the predetermined size of the region of interest along at least one axis, and/or decreasing a distance between a boundary of the region of interest and a boundary of the object. In some examples, decreasing the distance between the boundary of the region of interest and the object can include determining a contour of an object within the image frame and setting the boundary of the region of interest as the contour of the object within the image frame. In some cases, determining the contour of the object within the image frame can include determining pixels corresponding to the contour within the image frame.

In some aspects, determining that the image frame includes the object at least partially within the region of interest can include determining that the image frame includes one or more objects within a plurality of regions of interest within the image frame. In these aspects, adjusting the predetermined size or the predetermined shape of the region of interest can include adjusting a predetermined size or the predetermined shape of the plurality of regions of interest. Some aspects can further include overlaying, within the image frame, a visual graphic indicating the adjusted region of interest. These aspects can further include detecting an additional user input associated with the visual graphic, the additional user input indicating at least one additional adjustment to the adjusted region of interest.

Some aspects can further include: determining a plurality of candidate adjusted regions of interest corresponding to different adjustments to the predetermined size or the predetermined shape of the region of interest; sequentially displaying, within the image frame, a plurality of visual graphics corresponding to the plurality of candidate adjusted regions of interest; and determining a selection of one candidate adjusted region of interest of the plurality of candidate adjusted regions of interest based on detecting an additional user input associated with a visual graphic of the plurality of visual graphics corresponding to the one candidate adjusted region of interest.

In some aspects, the one or more image capture operations can include an auto-focus operation, an auto-exposure operation, and/or an auto-white-balance operation. In some cases, the image frame can be displayed after performing the one or more or more image capture operations.

In another example, a method is provided for improving one or more image processing operations in image frames. An example method can include detecting a user input corresponding to a selection of a location within an image frame. The method can also include determining whether the image frame includes one or more objects at least partially within a fixed region of interest surrounding the selected location. If the image frame includes one or more objects within the fixed region of interest, the method can adjust the fixed region of interest based on boundaries of the object at least partially within the image frame and then perform one or more image capture operations on image data within the adjusted region of interest. If the image frame does not include any objects within the fixed region of interest, the method can determine to not adjust the fixed region of interest and then perform one or more image capture operations on image data within the fixed region of interest.

In some aspects, one or more of the apparatuses described above is or is part of a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, an apparatus includes a camera or multiple cameras for capturing one or more images. In some aspects, the apparatus further includes a display for displaying one or more images, notifications, and/or other displayable data. In some aspects, the apparatus can include one or more sensors, which can be used for determining a location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1A is a block diagram illustrating an example architecture of an image capture and processing system, in accordance with some examples;

FIG. 1B, FIG. 1C, and FIG. 1D illustrate a Phase Detection Auto Focus (PDAF) camera system that is in phase, out of phase with a front focus, and out of phase with a back focus, respectively, in accordance with some examples;

FIG. 2A and FIG. 2B are illustrations of performing an image capture operation, in accordance with some examples;

FIG. 3A and FIG. 3B are conceptual diagrams illustrating operations of and interactions between components of an image processing system, in accordance with some examples;

FIG. 4 is a flow diagram illustrating an example of a process for improving one or more image capture operations in image frames, in accordance with some examples;

FIG. 5A and FIG. 5B are illustrations of an image capture operation, in accordance with some examples;

FIG. 5C, FIG. 5D, FIG. 5E, and FIG. 5F are illustrations of improved image capture operations, in accordance with some examples;

FIG. 6 is a flow diagram illustrating an example of a process for improving one or more image capture operations in image frames, in accordance with some examples; and

FIG. 7 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicking, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the photograph, such as auto-focus, auto-exposure, and auto-white-balance algorithms (collectively referred to as the “3As”). Additional camera operations applied before or during capture of a photograph include operations involving ISO, aperture size, f/stop, shutter speed, and gain. Other camera operations can configure post-processing of a photograph, such as alterations to contrast, brightness, saturation, sharpness, levels, curves, or colors.

In many camera systems, a user may direct or initiate an image processing operation. For instance, a camera device may display, to the user, a series of image frames when operating in an image-capture mode. The displayed image frames may be referred to or included in a “preview stream.” The camera device may update the image frames in the preview stream periodically and/or as the user moves the camera device. While viewing an image frame in a preview stream, the user may select a portion of the image frame corresponding to a desired location for an image processing operation to be performed. For example, if the camera is equipped with a touch screen or other type of interface configured for user input, the user may select (e.g., with a finger, stylus, or other suitable input mechanism) a location (such as one or more pixels) of the image frame. Non-limiting examples of suitable user input include double-tapping a location within a display and pressing down a location within a display for a predetermined amount of time (e.g., half a second, one second, etc.). In some cases, the location may include or correspond to an object of interest (e.g., a main subject or focal point) within the image frame. The camera device may perform an image processing operation on a region of the image frame surrounding and/or encompassing the selected location. This region may be referred to as a “region of interest” (ROI).

As will be explained in greater detail below, conventional image processing systems may perform image processing operations within ROIs of a standard and/or fixed size. In some cases, a fixed ROI may correspond to a box of a predetermined shape (e.g., a square, a rectangle, a circle, etc.) that includes a predetermined number of pixels or a predetermined size relative to the size (or resolution) of an image. The image processing operation may be performed on each pixel within the fixed ROI. Unfortunately, the fixed ROI may not accurately or precisely correspond to the object (or objects) intended to be selected by the user. For instance, the fixed ROI may include objects in addition to the selected object(s) and/or the fixed ROI may not include the entirety of the selected object(s).

Accordingly, systems, apparatuses, processes, and computer-readable media are described herein for improving the quality and/or efficiency of image processing operations. For instance, in some examples, the systems and techniques can determine and utilize dynamic ROIs whose shapes and/or sizes are customized to correspond to the boundaries of selected objects within image frames.

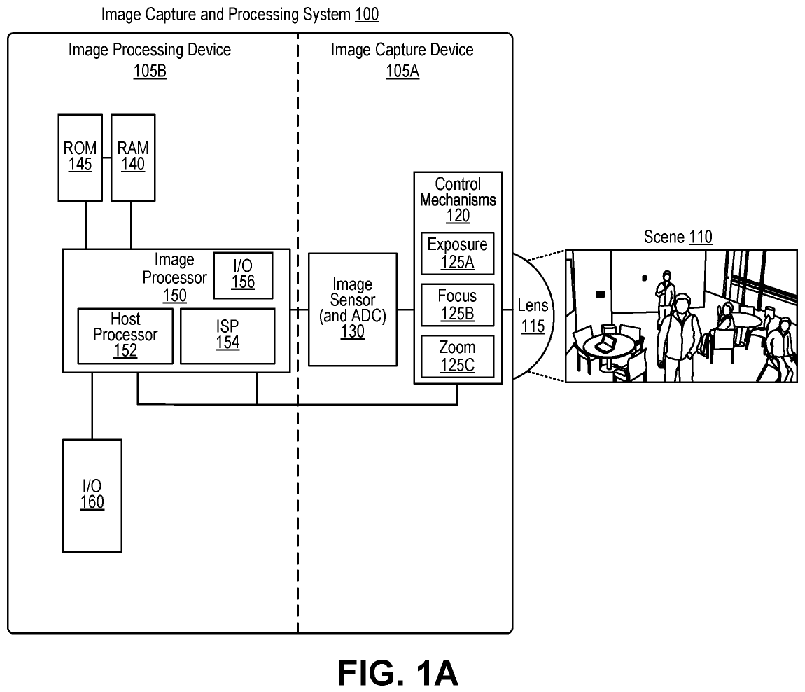

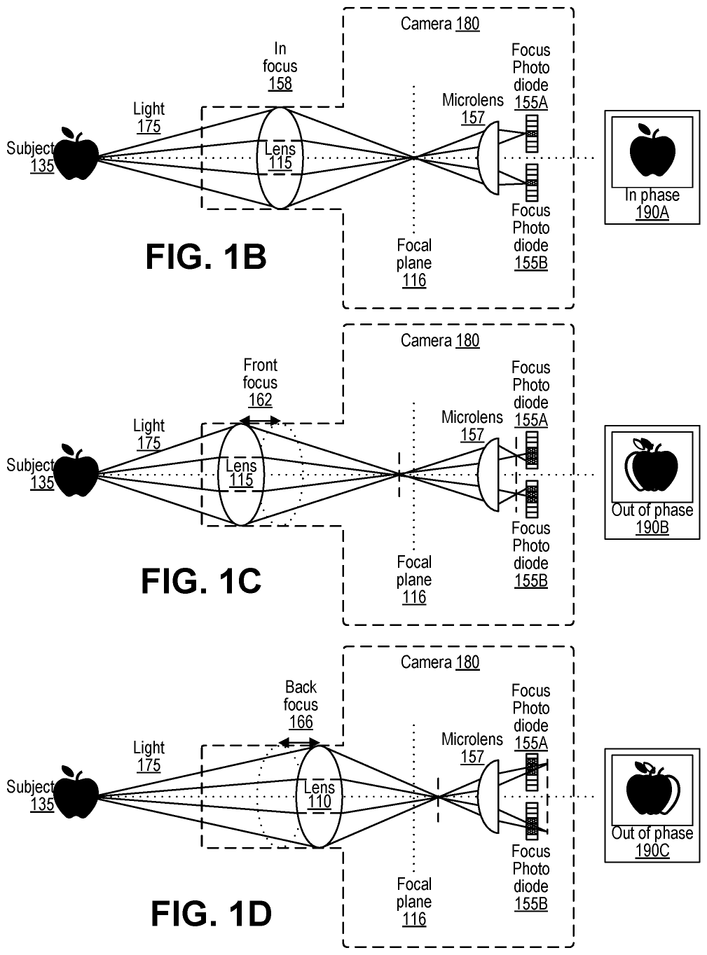

FIG. 1A is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties. In some cases, the one or more control mechanisms 120 may control and/or implement “3A” image processing operations.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 910 discussed with respect to the computing device 900. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicking, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/920, read-only memory (ROM) 145/925, a cache 912, a memory unit 915, another storage device 930, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 935, any other input devices 945, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations (referred to as the “3As,” as noted above). In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

FIG. 1B, FIG. 1C, and FIG. 1D provide examples of PDAF camera systems that may be integrated into the image capture and processing system 100. In particular, FIG. 1B illustrates a PDAF camera system that is in phase and therefore in focus. Rays of light 175 may travel from a subject 135 (e.g., an apple) through the lens 115 (also shown in FIG. 1A) that focuses a scene with the subject 135 onto an image sensor (such as the image sensor 130 shown in FIG. 1A), where the image sensor includes the focus photodiode 155A and the focus photodiode 155B, which correspond to focus pixels. The focus photodiodes 155A and 155B may be associated with one or two focus pixels (e.g., focus photodiode 155A and focus photodiode 155B may be two photodiodes of a single focus pixel sharing a single microlens 157 or focus photodiode 155A may be associated with a first focus pixel and focus photodiode 155B may be associated with a second focus pixel, both focus pixels sharing a single microlens 157) of the pixel array of the image sensor. In some cases, the light rays 175 may travel through the microlens 157 before falling on the focus photodiode 155A and the focus photodiode 155B. When the camera system 180 is in the “in focus” state 158 of FIG. 1B, the rays of light 175 may ultimately converge at a plane that corresponds to the position of the focus photodiode 155A and the focus photodiode 155B. When the camera system 180 is in the “in focus” state 158 of FIG. 1B, rays of light 175 may also converge at a focal plane 116 (also known as an image plane) after passing through the lens 115 but before reaching the microlens 157 and/or focus photodiodes 155A and 155B.

Because the camera 180 of FIG. 1B is in an in-focus state 158, data from focus photodiodes 155A and 155B is aligned, here represented by an image 190A showing a clear and sharp representation of the subject 135 due to this alignment, as opposed to the misaligned representations of the subject 135 caused by the out-of-phase states 162 and 166 in FIG. 1C and FIG. 1D respectively. The in-focus state 158 may also be referred to as an “in-phase” state, as the data from focus photodiode 155A and the focus photodiode 155B have no phase disparity, or have very little phase disparity (e.g., phase disparity falling below a predetermined phase disparity threshold).

FIG. 1C illustrates the PDAF camera system of FIG. 1B that is out of phase with a front focus. The PDAF camera system 180 of FIG. 1B is the same as the PDAF camera system 180 of FIG. 1B, but the lens 115 is moved closer to the subject 135 and further from the focus photodiodes 155A and 155B, and is therefore in a “front focus” state 162. The lens position for the “in focus” state 158 is still drawn in FIG. 1C as a dotted outline for reference, with a double-sided arrow indicating movement of the lens between the “front focus” 162 lens position and the “in focus” 158 lens position.

When the camera system 180 is in the “front focus” state 162 of FIG. 1C, the rays of light 175 may ultimately converge at a plane (denoted by a dashed line) before the position of the focus photodiode 155A and the focus photodiode 155B, that is, between the microlens 157 and the focus photodiodes 155A and 155B. The rays of light 175 may also converge at a position (denoted by another dashed line) before the focal plane 116 after passing through the lens 115 but before reaching the microlens 157 and/or focus photodiodes 155A and 155B. Because the light 175 in the camera 180 of FIG. 1C is out of phase in the “front focus” state 162, data from focus photodiodes 155A and 155B is misaligned, here represented by an image 190B showing misaligned black-colored and white-colored representations of the subject 135, where the direction of misalignment in the image 190B is related to the front focus state 162, and the distance of misalignment in the image 190B is related to the distance of the lens 115 from its position in the focused state 158.

FIG. 1D illustrates the PDAF camera system of FIG. 1B that is out of phase with a back focus. The PDAF camera system 180 of FIG. 1D is the same as the PDAF camera system 180 of FIG. 1B, but the lens 115 is moved further from the subject 135 and closer to the focus photodiodes 155A and 155B, and is therefore in a “back focus” state 166 (also known as a “rear focus” state). The lens position for the “in focus” state 158 is still drawn as a dotted outline for reference, with a double-sided arrow indicating movement of the lens between the lens position for the “back focus” state 166 and the lens position for the “in focus” state 158.

When the camera system 180 is in the “back focus” state 166 of FIG. 1D, the rays of light 175 may ultimately converge at a plane (denoted by a dashed line) beyond the position of the focus photodiode 155A and the focus photodiode 155B. The rays of light 175 may also converge at a position (denoted by another dashed line) beyond the focal plane 116 after passing through the lens 115 but before reaching the microlens 157 and/or focus photodiodes 155A and 155B. Because the light 175 in the camera 180 of FIG. 1D is out of phase in the “back focus” state 166, data from focus photodiodes 155A and 155B is misaligned, here represented by an image 190C showing misaligned black-colored and white colored representations of the subject 135, where the direction of misalignment in the image 190C is related to the back focus state 166, and the distance of misalignment in the image 190C is related to the distance of the lens 115 from its position in the focused state 158.

When the rays of light 175 converge before the plane of the focus photodiodes 155A and 155B as in the front focus state 162 or beyond the plane of the focus photodiodes 155A and 155B as in the back focus state 166, the resulting image produced by the image sensor may be out-of-focus or blurred. In the case that the image is out-of-focus, the lens 115 can be moved forward (toward the subject 135 and away from the photodiodes 155A and 155B) if the lens 115 is in the back focus state 166, or can be moved backward (away from the subject 135 and toward the photodiodes 155A and 155B) if the lens is in the front focus state 162. The lens 115 may be moved forward or backward within a range of positions which in some cases has a predetermined length R representing a possible range of motion of the lens in the camera system 180. The camera system 180, or a computing system therein, may determine a distance and direction of adjusting the position of the lens 115 to bring the image into focus based on one or more phase disparity values calculated as differences between data from two focus photodiodes that receive light from different directions, such as focus photodiodes 155A and 155B. The direction of movement of the lens 115 may correspond to a direction in which the data from the focus photodiodes 155A and 155B is determined to be out of phase, or whether the phase disparity is positive or negative. The distance of movement of the lens 115 may correspond to a degree or amount to which the data from the focus photodiodes 155A and 155B is determined to be out of phase, or the absolute value of the phase disparity.

The camera 180 may include motors (not pictured) that move the lens 115 between lens positions corresponding to the different states (e.g., front focus state 162, back focus state 166, and in focus state 158) and motor actuators (not pictured) that the computing system within the camera activates to actuate the motors. The camera 180 of FIG. 1B, FIG. 1C, and FIG. 1D may in some cases also include various additional non-illustrated components, such as lenses, mirrors, partially reflective (PR) mirrors, prisms, photodiodes, image sensors, and/or other components sometimes found in cameras or other optical equipment. In some cases, the focus photodiodes 155A and 155B may be referred to as PDAF photodiodes, PDAF diodes, phase detection (PD) photodiodes, PD diodes, PDAF pixel photodiodes, PDAF pixel diodes, PD pixel photodiodes, PD pixel diodes, focus pixel photodiodes, focus pixel diodes, pixel photodiodes, pixel diodes, or in some cases simply photodiodes or diodes.

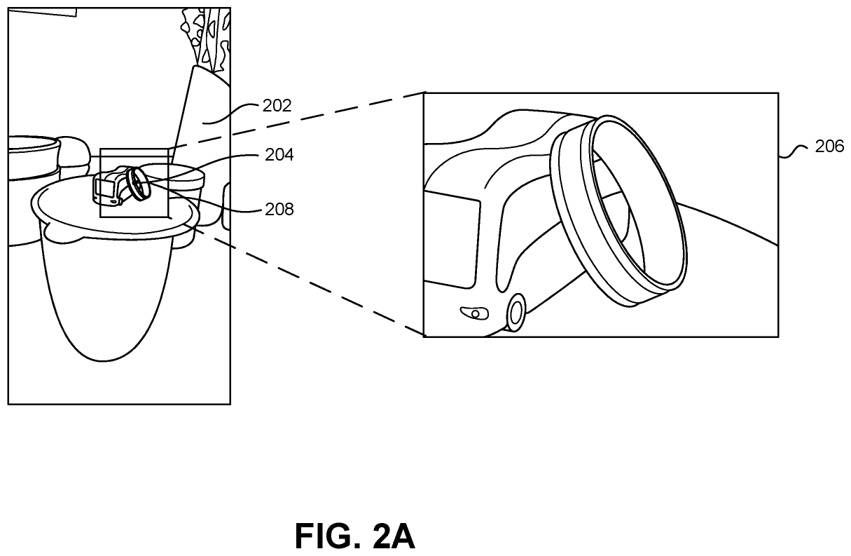

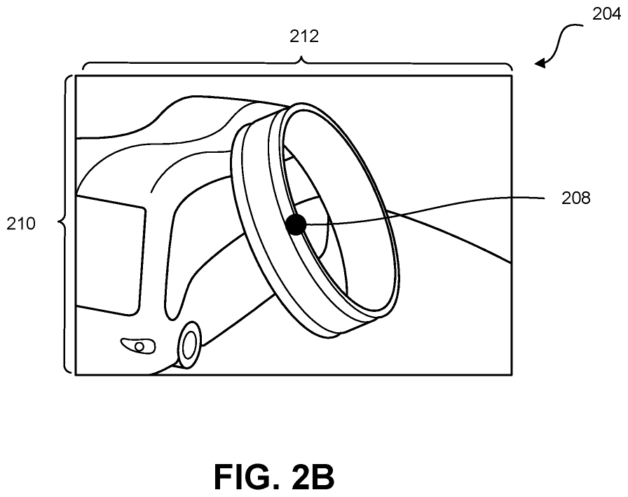

FIG. 2A and FIG. 2B illustrate an example of image frames that may be captured and/or processed while the image capture an processing system 100 performs an auto-focus operation or other “3A” operation. Specifically, FIG. 2A and FIG. 2B illustrate an example of a conventional auto-focus operation that utilizes a fixed ROI. As illustrated in FIG. 2A, the image capture device 105A of the system 100 may capture an image frame 202. In some cases, the image processing device 105B may detect that the user has selected a location 208 within the image frame 202 (e.g., while the image frame 202 is displayed within a preview stream). For instance, the image processing device 105B may determine that the user has provided input (e.g., using a finger, a gesture, a stylus, and/or other suitable input mechanism) that includes selection of a pixel or group of pixels corresponding to the location 208. The image processing device 105B may then determine an ROI 204 that includes the location 208. Image processor 150 may perform an auto-focus operation or other “3A” operation on image data within the ROI 204. The result of the auto-focus operation is illustrated in image frame portion 206 shown in FIG. 2A.

FIG. 2B illustrates an exemplary embodiment of the ROI 204. In this example, the image processing device 105B may determine and/or generate the ROI 204 by centering the location 208 within a region of the image frame 202 whose dimensions are defined by a predetermined width 212 and a predetermined height 210. In some cases, the predetermined width 212 and the predetermined height 210 may correspond to a preselected number of pixels (such as 10 pixels, 50 pixels, 100 pixels, etc.). Additionally or alternatively, the predetermined width 212 and the predetermined height 210 may correspond to preselected distances (such as 0.5 centimeters, 1 centimeter, 2 centimeters, etc.) within a display that displays the image frame 202 to a user. While FIG. 2B illustrates the ROI 204 as a rectangle, the ROI 204 may be of any alternative shape, including a square, a circle, an oval, among others.

In some cases, the image processing device 105B may determine pixels corresponding to the boundaries of the ROI 204 by accessing and/or analyzing information indicating coordinates of pixels within the image frame 202. As an illustrative example, the location 208 selected by the user may correspond to a pixel with an x-axis coordinate (in a horizontal direction) of 200 and a y-axis coordinate (in a vertical direction) of 300 within the image frame 202. If the image processing device 105B is configured to generate fixed ROIs whose height is 100 pixels and whose length is 200 pixels, the image processing device 105B may define the ROI 204 as a box with corners corresponding to the coordinates (150, 400), (250, 400), (150, 200), and (250, 200). The image processing device 105B may utilize any additional or alternative technique to generate fixed ROIs.

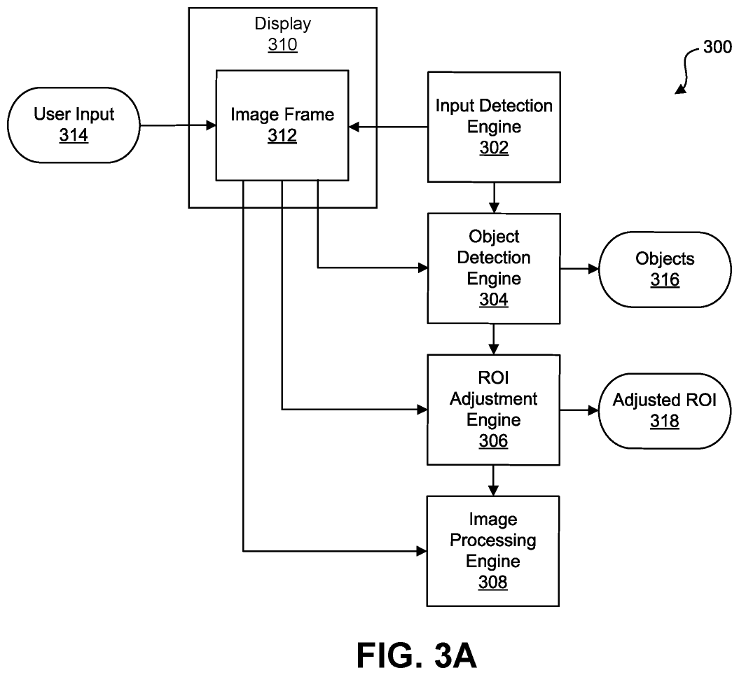

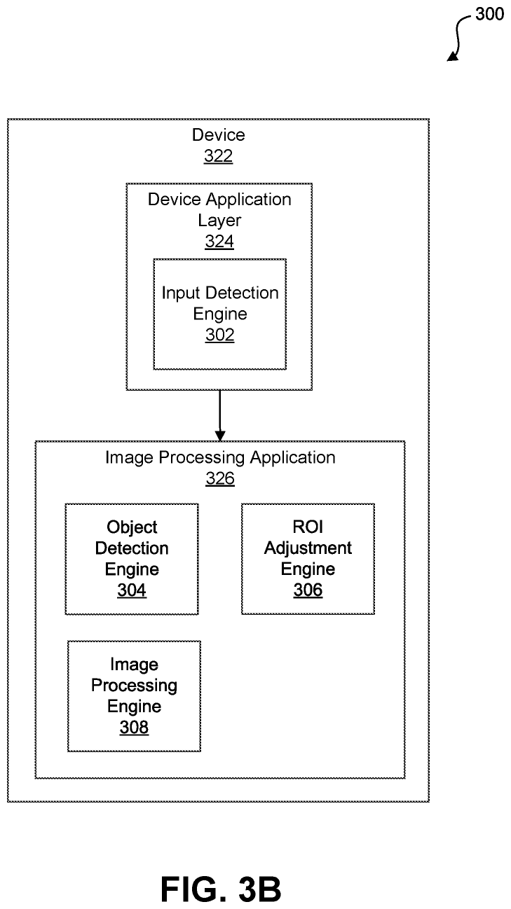

FIG. 3A is a block diagram illustrating an example of an image capture and processing system 300. In some embodiments, the image capture and processing system 300 is configured to improve the image processing operation illustrated in FIG. 2A and FIG. 2B. The image capture and processing system 300 may include any one or more components of the image capture and processing system 100 shown in FIG. 1, including the image capture device 105A, the image processing device 105B, and the lens 115. In some cases, all or a portion of the components of the image capture and processing system 300 may be implemented within a computing device, such as a device 322 shown in FIG. 3B. The device 322 can include any suitable device, such as a mobile device (e.g., a mobile phone), a desktop computing device, a tablet computing device, an extended reality (XR) device (e.g., a virtual reality (VR) headset, an augmented reality (AR) headset, AR glasses, or other XR device), a wearable device (e.g., a network-connected watch or smartwatch, or other wearable device), a server computer, an autonomous vehicle or computing device of an autonomous vehicle, a robotic device, a television, and/or any other computing device with the resource capabilities to perform the image processing operations described herein.

As shown in FIG. 3A, the image capture and processing system 300 may include a display 310. The image capture and processing system 300 can capture image frames and then display the image frames within the display 310. The display 310 may include any suitable type of screen or interface configured to visually display image data. In some cases, the image capture and processing system 300 can display captured image frames to enable a user to provide input that directs the image capture and processing system 300 to perform one or more image processing operations on the image frames. The image capture and processing system 300 may include one or more engines configured to perform the image processing operations. As shown in FIG. 3A, these engines may include an input detection engine 302, an object detection engine 304, an ROI adjustment engine 306, and an image processing engine 308.

As shown in FIG. 3A, the image capture and processing system 300 can capture and display an image frame 312. The input detection engine 302 may then monitor the display 310 to detect user input 314 provided to the image frame 312. In some cases, the user input 314 can include and/or correspond to a user selecting a location (e.g., a pixel) within the image frame 312. The user input 314 may represent a request to perform an image processing operation (such as an auto-focus algorithm) on image data surrounding and/or nearby the selected location. In some cases, the image capture and processing system 300 can determine that the user input 314 represents the request to perform the image processing operation based on determining that the user provides the user input 314 (e.g., touches the display 310) for at least a threshold amount of time (e.g., 0.5 seconds, 1 second, etc.) The input detection engine 302 may periodically or continuously monitor the display 310 to detect the user input 314. For instance, the input detection engine 302 may monitor the display 310 while the image frame 312 is displayed within a preview stream and/or monitor the display 310 after the image frame 312 has been stored to a memory (e.g., a main memory) of the image capture and processing system 300. In some cases, the input detection engine 302 can detect user input associated with selection of multiple locations (e.g., multiple pixels). In some examples, each selected location can correspond to a different fixed ROI that includes one or more objects.

In some cases, the object detection engine 304 may perform an object detection operation or algorithm on image data within the image frame 312 based at least in part on user input 314. The goal of this object detection operation or algorithm may be to identify one or more objects within a region of the image frame 312 surrounding and/or nearby the location corresponding to the user input 314. The term “object,” as used herein, generally refers to a depiction of an item or entity (such as a person, device, animal, vehicle, plane, landscape feature, among others) within an image frame. In an illustrative embodiment, the object detection engine 304 may detect objects within a fixed ROI that is centered (or approximately centered) around the selected location. The object detection engine 304 may determine the fixed ROI using any suitable method or technique, including the techniques described in connection with FIG. 2A and FIG. 2B. In examples where the input detection engine 302 detects user input associated with selection of multiple locations, the object detection engine 304 can detect one or more objects that are at least partially included within fixed ROIs corresponding to each selected location.

In some examples, the object detection engine 304 implements one or more object detection operations or algorithms (e.g., a facial detection and/or recognition algorithm, a feature detection and/or recognition algorithm, an edge detection algorithm, a boundary tracing function, any combination thereof, and/or other object detection and/or recognition technique) to detect objects within the image frame 312. Any object detection technique can be used to detect an object. In some cases, feature detection can be used to detect (or locate) features of objects. Based on the features, object detection and/or recognition can detect an object and in some cases can recognize and classify the detected object into a category or type of object. For instance, feature recognition may identify a number of edges and corners in an area of the scene. Object detection may detect that the detected edges and corners in the area all belong to a single object. In the event face detection is performed, the face detection may identify that the object is a human face. Object recognition and/or face recognition may further identify the identity of the person corresponding to that face.

In some implementations, the object detection operation or algorithm can be based on a machine learning model trained using a machine learning algorithm on images of the same types of objects and/or features that may extract features of the image and detect and/or classify the object comprising those features based on the training of the model by the algorithm. For instance, the machine learning algorithm may be a neural network (NN), such as a convolutional neural network (CNN), a time delay neural network (TDNN), a deep feed forward neural network (DFFNN), a recurrent neural network (RNN), an auto encoder (AE), a variation AE (VAE), a denoising AE (DAE), a sparse AE (SAE), a markov chain (MC), a perceptron, or some combination thereof. The machine learning algorithm may be a supervised learning algorithm, an unsupervised learning algorithm, a semi-supervised learning algorithm, a generative adversarial network (GAN) based learning algorithm, any combination thereof, or other learning techniques.

In some implementations, a computer vision-based feature detection technique or algorithm can be used. Different types of computer vision-based object detection algorithms can be used. In one illustrative example, a template matching-based technique can be used to detect an object in an image. Various types of template matching algorithms can be used. One example of a template matching algorithm can perform Haar or Haar-like feature extraction, integral image generation, Adaboost training, and cascaded classifiers. Such an object detection technique performs detection by applying a sliding window (e.g., having a rectangular, circular, triangular, or other shape) across an image. An integral image may be computed to be an image representation evaluating particular regional features, for example rectangular or circular features, from an image. For each current window, the Haar features of the current window can be computed from the integral image noted above, which can be computed before computing the Haar features.

The Harr features can be computed by calculating sums of image pixels within particular feature regions of the object image, such as those of the integral image. In faces, for example, a region with an eye is typically darker than a region with a nose bridge or cheeks. The Haar features can be selected by a learning algorithm (e.g., an Adaboost learning algorithm) that selects the best features and/or trains classifiers that use them, and can be used to classify a window as a particular object (e.g., a face or other object) window or a different object (e.g., a non-face window) effectively with a cascaded classifier. A cascaded classifier includes multiple classifiers combined in a cascade, which allows background regions of the image to be quickly discarded while performing more computation on object-like regions. Using a face as an example of an object, the cascaded classifier can classify a current window into a face category or a non-face category. If one classifier classifies a window as a non-face category, the window is discarded. Otherwise, if one classifier classifies a window as a face category, a next classifier in the cascaded arrangement will be used to test again. Until all the classifiers determine the current window is a face (or other object), the window will be labeled as a candidate for being the particular object (e.g., a face or other object). After all the windows are detected, a non-max suppression algorithm can be used to group the windows around each face to generate the final result of one or more detected objects (e.g., faces or other object in an image).

In some cases, an object detection operation or algorithm may detect and/or output boundaries of an object. The term “boundary of an object,” as used herein, can refer to a visual or physical distinction between the object and one or more other objects. In some examples, the boundary of an object may (approximately) correspond to and/or be defined by the contour of the object (e.g., the shape, edges, and/or outline of the object). However, the boundary of an object may not necessarily directly or exactly align with the contour of the object (e.g., the boundary of the object may be determined within a certain distance and/or number of pixels from the contour of the object). In some cases, an object detection operation or algorithm may output an indication of an object boundary as a set of pixel coordinates corresponding to the boundary of the object. Additionally or alternatively, an object detection operation or algorithm may output an indication of an object boundary as one or more curves (e.g., equations) corresponding to the boundary of the object. In one embodiment, the pixel coordinates and/or curves may precisely follow the contour of the object (e.g., define the outline of the object). In other embodiments, the pixel coordinates and/or curves may approximately follow the boundary of the object. For instance, performing an object detection algorithm within a region of interest may output pixel coordinates and/or curves that define a bounding box of the object, or a polygon (such as an alpha shape or a convex hull) that includes the object.

The object detection operation or algorithm performed by the object detection engine 304 may detect one or more objects 316 within a region (e.g., a fixed ROI) of the image frame 312. In one example, the object detection engine 304 may detect each object that is fully depicted within the region (e.g., each object whose boundaries are fully included within the region). In another example, the object detection engine 304 may detect each object that is at least partially included within the region. In a further example, the object detection engine 304 may detect that multiple objects are at least partially included within the region but determine that one or more objects are more important and/or more relevant than other detected objects. For instance, the object detection engine 304 may determine that it is more likely a user intended to select a first object than a second object as the subject of an image processing operation. The object detection engine 304 may determine that the first object is more important and/or more relevant than the second object based on various factors, such as the pixel selected by the user corresponding to the first object, the first object being larger than the second object, the first object being in the foreground (rather than the background) of the scene depicted in the image frame 312, and/or the first object being a certain type of object. As an illustrative example, the object detection engine 304 may determine that a fixed ROI includes depictions of a face and a tree. The object detection engine 304 may determine that the face is likely to be more important within the image frame 312 than the tree and, therefore, determine that the face is the intended subject of the image processing operation. In another illustrative example, the object detection engine 304 may detect that a fixed ROI includes two trees and determine that the intended subject of the image processing operation is the tree closer to the foreground of the depicted scene.

In some examples, the object detection engine 304 may perform object detection within the image frame 312 in response to user input 314 (e.g., only after the input detection engine 302 detects the user input 314). For instance, while the object detection engine 304 may be capable of detecting objects within the image frame 312 prior to receiving the user input 314, the image capture and processing system 300 may reduce consumption of power and computing resources by waiting until the user input 314 is detected. Because the user input 314 indicates a particular region and/or object that the user wishes to enhance or refine using an image processing operation, performing object detection within other regions of the image frame 312 may be unnecessary. Thus, by waiting to perform object detection until receiving user input, the image capture and processing system 300 may facilitate performing efficient and customizable image processing operations on particular objects within image frames.

After the object detection engine 304 detects one or more objects 316, the ROI adjustment engine 306 may determine an adjusted ROI 318 based on one or more boundaries of the one or more objects 316. For instance, if the object detection engine 304 searched image content within a fixed ROI to detect objects within the image frame 312, the object detection engine 304 may adjust one or more boundaries of the fixed ROI to more accurately correspond to and/or follow the boundaries of the one or more objects 316. In some cases, the goal of adjusting the fixed ROI may be to decrease distances between boundaries of the one or more objects 316 and boundaries of the fixed ROI within the image frame 312. While the boundaries of the adjusted ROI 318 may not necessarily precisely follow the boundaries of the one or more objects 316, the adjusted ROI 318 may more accurately reflect the shape and/or size of the one or more objects 316.

Examples of adjusting the fixed ROI include, without limitation, decreasing the size of the fixed ROI, increasing the size of the fixed ROI, changing the location of the fixed ROI, changing the shape of the fixed ROI, combinations therefore, or any additional type of adjustment to the fixed ROI. In an illustrative example, adjusting the fixed ROI can include increasing or decreasing the predetermined size of the fixed ROI along one or more axes (e.g., the x-axis, the y-axis, and/or a radial axis). The ROI adjustment engine 306 can adjust any combination of the predetermined size and shape of the fixed ROI, including only the size, only the shape, or both the size and the shape of the fixed ROI. For example, the ROI adjustment engine 306 can adjust each dimension (e.g., the height and width) of the fixed ROI by the same amount, which may adjust the predetermined size of the fixed ROI but not the predetermined shape of the fixed ROI. In another example, the ROI adjustment engine 306 can adjust one or more dimensions of the fixed ROI in a manner that changes the predetermined shape of the fixed ROI but does not change the predetermined size of the fixed ROI (e.g., the adjusted ROI may include the same number of pixels as the fixed ROI). In a further example, the ROI adjustment engine 306 can adjust the fixed ROI by setting the boundaries of the fixed ROI as a bounding box determined for an object based on the object detection algorithm performed by the object detection engine 304.

As mentioned above, in some cases the object detection engine 304 may determine pixel coordinates corresponding (or approximately corresponding) to the boundaries of the one or more objects 316. In these cases, the ROI adjustment engine 306 may set the boundaries of the adjusted ROI 318 as the determined pixel coordinates. Additionally, if the object detection engine 304 determines that the fixed ROI includes multiple objects that are to be the subject of an image processing operation, the ROI adjustment engine 306 may determine a single adjusted ROI 318 that encompasses each object, or the object detection engine 304 may determine multiple adjusted ROIs 318 that each encompass a single object. Further, the ROI adjustment engine 306 may quickly and/or dynamically determine the adjusted ROI 318. For instance, the ROI adjustment engine 306 may determine the adjusted ROI 318 while the image frame 312 is still displayed to the user within the display 310 (e.g., within a preview stream). In other examples, the ROI adjustment engine 306 may determine the adjusted ROI 318 while the image frame 312 is no longer being displayed to the user.

In some examples, if the object detection engine 304 determines a plurality of fixed ROIs that each at least partially include one or more objects, the ROI adjustment engine 306 can determine adjustments for all or a portion of the fixed ROIs. For example, the ROI adjustment engine 306 can adjust the predetermined size and/or shape of the plurality of fixed ROIs. Further, the object detection engine 304 can determine a plurality adjustments for a single fixed ROI. For example, the ROI adjustment engine 306 can determine multiple candidate (e.g., potential) adjustments for the fixed ROI. In one example, the ROI adjustment engine 306 can determine multiple candidate adjustments by implementing various object detection algorithms within the fixed ROI. The various object detection algorithms can output different adjustments to the predetermined size and/or shape of the fixed ROI. In some cases, the ROI adjustment engine 306 can select one adjustment of a plurality of candidate ROI adjustments to be implemented within the image frame 312. In an illustrative example, the ROI adjustment engine 306 can select a candidate ROI adjustment based on a comparison of the plurality of candidate ROI adjustments. For instance, the ROI adjustment engine 306 can determine which candidate ROI adjustment best fits the size, shape, and/or contour of the one or more objects within the fixed ROI. In other examples, the ROI adjustment engine 306 can select a candidate ROI adjustment based at least in part on user input indicating a selection. For example, as will be explained more below, the ROI adjustment engine 306 can sequentially display (e.g., within the display 310) visual graphics indicating the candidate ROI adjustments. The ROI adjustment engine 306 can enable the user to provide input (e.g., a touch input) associated with a particular visual graphic indicating selection of a corresponding candidate ROI adjustment.

In some examples, the ROI adjustment engine 306 can enable the user to provide one or more additional adjustments to the adjusted ROI 318. For example, the ROI adjustment engine 306 can display (e.g., within the display 310) a visual graphic indicating the shape, size, and/or outline of the adjusted ROI 318. The ROI adjustment engine 306 can then detect user input corresponding to adjustments to the boundaries of the adjusted ROI 318. For example, the ROI adjustment engine 306 can enable the user to move, slide, drag, or otherwise adjust one or more boundaries of the adjusted ROI 318. By enabling the user to select a candidate ROI adjustment and/or provide additional ROI adjustments, the ROI adjustment engine 306 can tailor and/or customize image capture or image processing operations based on the user's personal preferences.

In some embodiments, the image processing engine 308 may perform one or more image processing and/or image capture operations on image data within the adjusted ROI 318. In an illustrative example, the image processing engine 308 may perform an auto-focus operation, such as PDAF or CDAF operations described above, on the image data within the adjusted ROI 318 prior to or during capture of the image frame 312 (e.g., while the image frame 312 is displayed within a preview stream). Non-limiting examples of additional image processing operations that may be performed by the image processing engine 308 include other types of “3A” operations, other types of automatic image processing operations performed prior to or during image capture, and other types of exposure, focus, metering, and/or zoom operations performed after image capture and/or storage. Notably, the image processing engine 308 may perform the one or more image processing operations on image data within the adjusted ROI 318 while not processing image data included within the fixed ROI and outside the adjusted ROI 318. Thus, if the ROI adjustment engine 306 changes (e.g., decreases) the size of the fixed ROI while determining the adjusted ROI 318, the image processing engine 308 may perform the one or more image processing operations on a different (e.g., smaller) portion of image data than conventional image processing systems that implement fixed ROIs. Such smaller ROIs may increase the efficiency of performing image processing operations, as well as improve the quality and/or appearance of image frames containing processed image data.

The image capture and processing system 300 can perform various actions on the image frame 312 after performing the one or more image processing operations on image data within the adjusted ROI 318. In one example, the image capture and processing system 300 can display image frame 312 (with the processed image data) within the display 310. In this way, the user can visualize the results of the image processing operation. The user can then determine whether to save the processed image frame 312 (e.g., to a main memory of the image capture and processing system 300), delete the processed image frame 312, direct the image capture and processing system 300 to perform one or more additional image processing operations on the image frame 312, or perform any additional or alternative action on the image frame 312.

FIG. 3B illustrates a block diagram of an exemplary implementation of the image capture and processing system 300 within the device 322. As shown, the engines of the image capture and processing system 300 may be implemented within various hardware and/or software components of the device 322. In one example, the input detection engine 302 may reside within a device application layer 324. The device application layer 324 may represent a portion and/or interface of a camera application that controls the output of the display 310 shown in FIG. 3A. In some cases, the input detection engine 302 may monitor user input provided to the display 310 while operating within or as part of the device application layer 324. In an illustrative example, the input detection engine 302 may detect and/or receive a notification (e.g., a “touch flag”) indicating that the user has selected (e.g., touched or clicked on) a particular location of the display 310. The input detection engine 302 may then send an indication of this input (e.g., an indication of the selected location) to an image processing application 326. In some cases, the input detection engine 302 may also send, to the image processing application 326, a size of a fixed ROI that is to be used for object detection surrounding the selected location.

The image processing application 326 may include any type or form of application configured to perform one or more image processing operations on image data captured by the device 322. In an illustrative example, the image processing application 326 may include a “3A” application capable of performing an auto-focus algorithm. As shown in FIG. 3B, the image processing application 326 may include the object detection engine 304, the ROI adjustment engine 306, and the image processing engine 308 of the image capture and processing system 300. These engines may utilize the information sent from the input detection engine 302 to detect one or more objects within the fixed ROI, determine an adjusted ROI based on boundaries of the one or more objects, and then perform an image processing operation on image data within the adjusted ROI.

In certain embodiments, the image capture and processing system 300 may determine whether adjusting a fixed ROI is appropriate and/or desirable. For instance, the image capture and processing system 300 may decide to not adjust the fixed ROI based on determining that the size and shape of the fixed ROI sufficiently corresponds to boundaries of one or more detected objects. In another example, the image capture and processing system 300 may determine that adjusting the fixed ROI is likely unnecessary due to the fixed ROI not including any objects that would benefit from an image processing operation.

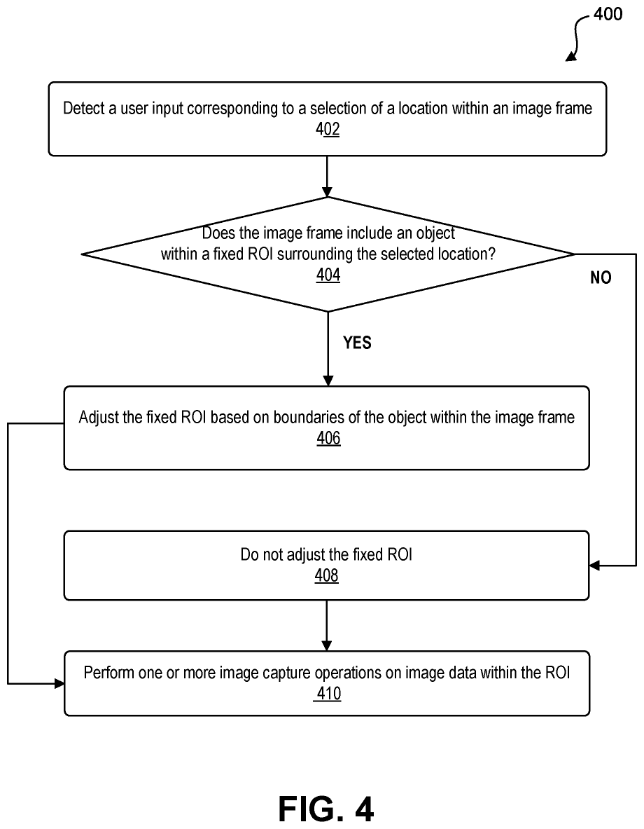

FIG. 4 is a flowchart illustrating an example of a process 400 for improving one or more image processing operations by determining whether a fixed ROI should be adjusted. At block 402, the process 400 includes detecting a user input corresponding to a selection of a location within an image frame. For instance, the process 400 can include monitoring a user interface of a device equipped with a camera to detect when a user has selected one or more pixels within an image frame displayed on the user interface.

At block 404, the process 400 includes determining whether the image frame includes an object within an ROI surrounding the selected location, wherein the ROI includes the selected location, and wherein the ROI has a predetermined size (i.e., a fixed ROI). For instance, the process 400 can include performing an object detection operation or algorithm on image data within the fixed ROI of the image frame. In one example, determining that the image frame includes an object within the fixed ROI can include determining that the fixed ROI fully encompasses an exterior boundary of one or more objects. Conversely, determining that the image frame does not include an object within the fixed ROI can include determining that the fixed ROI does not fully encompass an exterior boundary of any object. In another example, determining that the image frame includes an object within the fixed ROI can include determining that the fixed ROI encompasses at least a portion of an exterior boundary of one or more objects. Conversely, determining that the image frame does not include an object within the fixed ROI can include determining that the fixed ROI does not encompass any portion of an exterior boundary of any object.

If the decision determined at block 404 is “No,” the process 400 may proceed to block 408. At block 408, the process 400 includes declining to adjust the fixed ROI. For instance, the process 400 includes determining to perform one or more image processing operations on image data corresponding to each pixel within the fixed ROI. After block 408, the process 400 proceeds to block 410, which includes performing the one or more image processing operations on the image data within the fixed ROI. If the decision determined at block 404 is “Yes,” the process 400 may proceed to block 406. At block 406, the process 400 includes adjusting the fixed ROI based at least in part on the decision. In some embodiments, the fixed ROI may be adjusted based on boundaries of the one or more objects detected within the image frame. For instance, the process 400 may include setting the boundaries of the ROI as pixels corresponding to the boundaries of the one or more detected objects. The process 400 may then proceed to block 410, which includes performing the one or more image processing and/or image capture operations on the image data within the adjusted ROI.

The image processing techniques and solutions described above may improve the quality of image processing operations performed on portions of image frames. For instance, re-fining the shape and/or size of a fixed ROI based on the shape and/or size of a specific object may enable an image processing operation to be performed on image data corresponding to the specific object while excluding image data corresponding to other objects. As a result, the effects of the image processing operation may be more noticeable and/or of higher quality. These improvements may be especially pronounced in image frames that include highly detailed objects, as well as in image frames that include objects in both the foreground and the background. Further, the disclosed techniques and solutions may enable users to more precisely and efficiently customize images in accordance with their personal taste, thereby increasing overall user satisfaction.

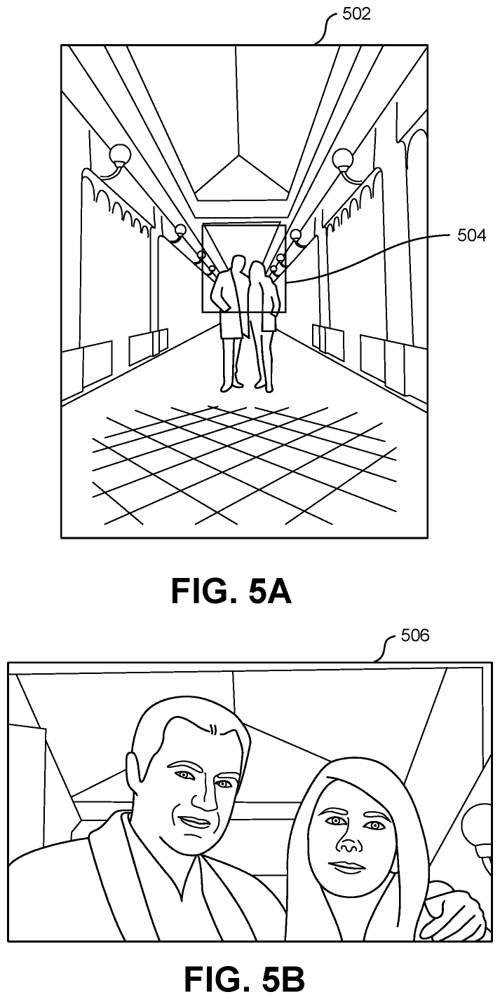

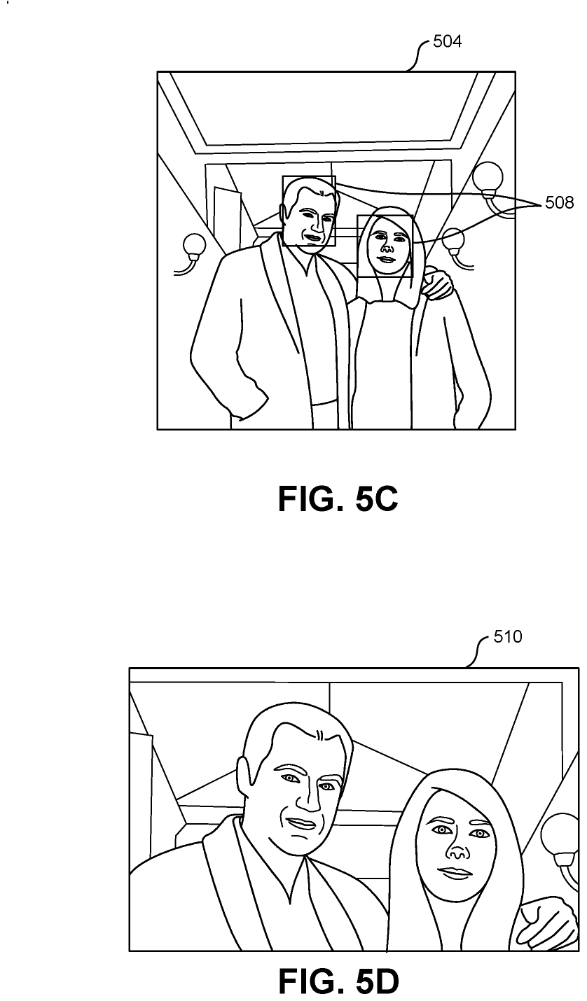

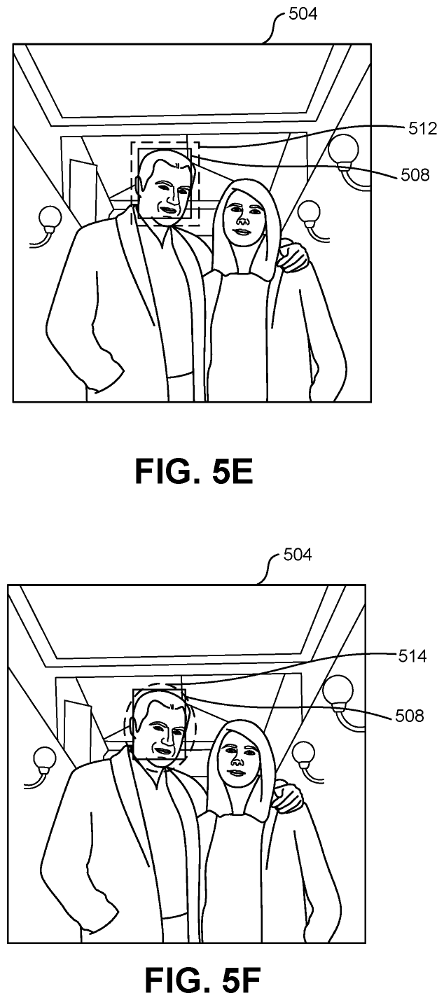

FIG. 5A, FIG. 5B, FIG. 5C, and FIG. 5D include images illustrating the improvements provided by the disclosed image processing techniques and solutions. Specifically, FIG. 5A illustrates an example image frame 502 that includes a fixed ROI 504. As shown in FIG. 5A, the fixed ROI 504 includes two faces. FIG. 5B illustrates an image frame portion 506 corresponding to image data within the fixed ROI 504 after an auto-focus algorithm has been performed on the image data in accordance with conventional image processing systems. For instance, the entirety of the image data in the image frame portion 506 has been processed using the auto-focus algorithm. In contrast, FIG. 5C illustrates adjusted ROIs 508 that correspond to a subset of the image data within the fixed ROI 504. As shown in FIG. 5C, the boundaries of the adjusted ROIs 508 approximately correspond to boundaries of the two faces. The disclosed image capture and processing systems may determine the adjusted ROIs 508 based at least in part on performing object detection within the fixed RO1 504. FIG. 5D illustrates an image data portion 510 corresponding to image data within the fixed ROI 504 after an auto-focus algorithm has been performed on the image data within the adjusted ROIs 508. In comparison with the faces illustrated in FIG. 5B, the faces illustrated in FIG. 5D have greater clarity, and the processed image frame has a greater overall quality.

FIG. 5E and FIG. 5F include images illustrating additional improvements provided by the disclosed image and processing techniques and solutions. Specifically, FIG. 5E illustrates the fixed ROI 504 and a portion of the adjusted ROI 508 shown in FIG. 5C. FIG. 5E also illustrates an additional adjusted ROI 512, which corresponds to the adjusted ROI 508 after the adjusted ROI 508 has been further adjusted based on user input. As shown, the shape of the additional adjusted ROI 512 (e.g., rectangular) is similar to the shape of the adjusted ROI 508. However, the size of the additional adjusted ROI 512 is different (e.g., larger) than the size of the adjusted ROI 508. In one example, the ROI adjustment engine 306 can display a visual graphic that indicates the shape, size, and/or contour (e.g., outline) of the adjusted ROI 508. The ROI adjustment engine 306 can generate the additional adjusted ROI 512 based on detecting user input corresponding to moving (e.g., dragging) one or more boundaries of the visual graphic. For example, the ROI adjustment engine 306 can increase the height and/or width of the adjusted ROI 508 based on detecting user input corresponding to moving a boundary of the adjusted ROI 508 away from a central point of the adjusted ROI 508. Similarly, the ROI adjustment engine 306 can decrease the height and/or width of the adjusted ROI 508 based on detecting user input corresponding to moving a boundary of the adjusted ROI 508 towards the central point of the adjusted ROI 508. The ROI adjustment engine 306 can apply additional adjustments to the adjusted ROI 508 in any suitable manner and/or based on various types of user input.

Further, FIG. 5F illustrates the fixed ROI 504 and a portion of the adjusted ROI 508 shown in FIG. 5C. FIG. 5F also illustrates an additional adjusted ROI 514, which corresponds to a candidate (e.g., potential) adjusted ROI. For example, the ROI adjustment engine 306 can determine the adjusted ROI 508, the additional adjusted ROI 514, and/or any additional candidate adjusted ROIs. The ROI adjustment engine 306 can display visual graphics corresponding to the shape, size, and/or contour of the candidate adjusted ROIs. In one example, the ROI adjustment engine 306 can simultaneously overlay multiple visual graphics onto the image frame 502. In another example, the ROI adjustment engine 306 can sequentially display a plurality or series of visual graphics. For instance, the ROI adjustment engine 306 can display a single visual graphic at a time. In some cases, the ROI adjustment engine 306 can display each visual graphic for a predetermined amount of time (e.g., 1 second, 3 seconds, etc.). In this way, the ROI adjustment engine 306 can enable the user to individually view and/or evaluate each candidate adjusted ROI. In one example, the ROI adjustment engine 306 can cycle through a plurality of visual graphics corresponding to a plurality of candidate adjusted ROIs. While a particular visual graphic is displayed, the ROI adjustment engine 306 can detect user input corresponding to selection of the particular visual graphic. For instance, the ROI adjustment engine 306 can determine that the user has selected (e.g., touched, clicked on, verbally acknowledged, etc.) the particular visual graphic. The ROI adjustment engine 306 can then implement the corresponding candidate adjusted ROI within the image frame 502. As shown in FIG. 5F, the adjusted ROI 508 may be of a different shape (e.g., a rectangle) than the additional adjusted ROI 514 (e.g., an oval). In an illustrative example, the user may select the visual graphic corresponding to the additional adjusted ROI 514 based on determining that the oval shape more accurately corresponds to the shape of the person's head within the image frame 502.

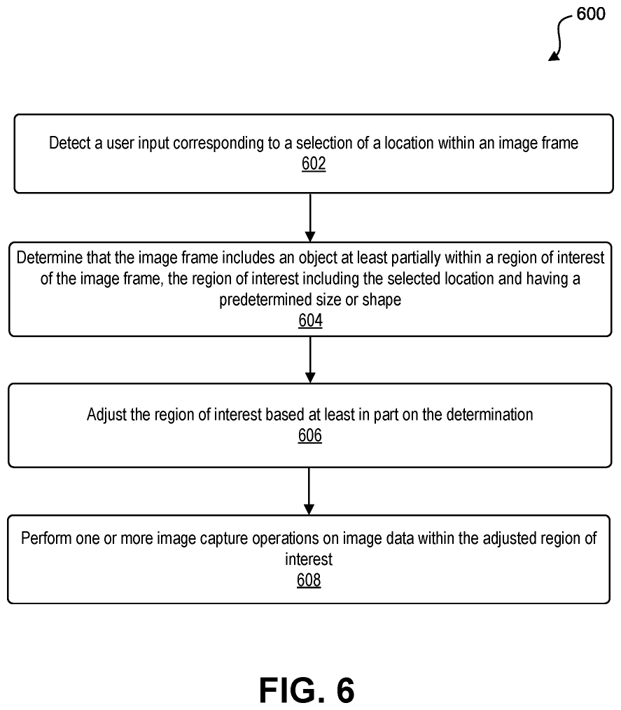

FIG. 6 is a flow diagram illustrating an example process 600 for improving one or more image processing operations in image frames. For the sake of clarity, the process 600 is described with references to the image processing and capture system 300 shown in FIG. 3A and FIG. 3B. The steps outlined herein are examples and can be implemented in any combination thereof, including combinations that exclude, add, or modify certain steps.

At step 602, the process 600 includes detecting a user input corresponding to a selection of a location within an image frame. For instance, the input detection engine 302 can detect the user input 314 corresponding to a selection of a location within the image frame 312. In one example, the image processing and capture system 300 can receive the image frame 312 within a preview stream of frames including image frames captured by a camera device while the camera device is in an image capture mode. The input detection engine 302 can monitor the image frame 312 while the image frame 312 is displayed on the display 310 (e.g., within the preview stream). The input detection engine 302 can monitor and/or detect any suitable type of user input corresponding to a selection of a location within the image frame 312. In a non-limiting example, the input detection engine 302 can detect that a user has touched or otherwise selected (e.g., with a finger or stylus) a location within the display 310 corresponding to one or more pixels of the image frame 312. In some cases, the input detection engine 302 can determine that the image frame 312 includes one or more objects within a plurality of ROIs. For instance, the input detection engine 302 can detect user input corresponding to selection of multiple locations within the image frame 312.

At step 604, the process 600 includes determining that the image frame includes an object at least partially within a region of interest of the image frame, the region of interest including the selected location and having a predetermined size and/or a predetermined shape. For instance, the object detection engine 304 can determine that the image frame 312 includes the object 316 within an ROI of the image frame 312. In one example, the ROI can be a fixed ROI (e.g., an ROI having a predetermined shape, size, and/or number of pixels). The object detection engine 304 can perform various types of object detection operations or algorithms to detect the object 316 within the fixed ROI (e.g., a facial detection and/or recognition algorithm, a feature detection and/or recognition algorithm, an edge detection algorithm, a boundary tracing function, any combination thereof, and/or other object detection and/or recognition techniques). Referring to FIG. 5C, the object detection engine 304 can detect the two faces within the fixed ROI 504. Further, if the input detection engine 302 determines that the image frame 312 includes a plurality of ROIs (at step 602), the object detection engine 304 can detect one or more objects that are at least partially within the plurality of ROIs.

At step 606, the process 600 includes adjusting the predetermined size and/or the predetermined shape of the region of interest based at least in part on the determination that the image frame includes the object at least partially within the region of interest of the image frame. For instance, the ROI adjustment engine 306 can adjust the ROI based at least in part on the determination that the image frame 312 includes the object 316 within the ROI. The ROI adjustment engine 306 can adjust the ROI in various ways. In one example, the ROI adjustment engine 306 can decrease the predetermined size of the ROI along at least one axis. In another example, the ROI adjustment engine 306 can increase the predetermined size of the ROI along at least one axis. In a further example, the ROI adjustment engine 306 can adjust the predetermined shape of the ROI based on an object detection algorithm (e.g., the object detection algorithm used to detect the object within the image frame 312). For instance, the ROI adjustment engine 306 can determine a bounding box for the object based on the object detection algorithm and set the ROI as the bounding box. Additionally or alternatively, the ROI adjustment engine 306 can adjust the size and/or shape of the ROI in any manner that decreases the distance between one or more boundaries of the object 316 and one or more boundaries of the ROI. For instance, the ROI adjustment engine 306 can determine the one or more boundaries of the object 316 and set the one or more boundaries of the ROI as the one or more boundaries of the object 316. In some cases, the one or more boundaries of the object 316 can correspond to (or approximately correspond to) the shape, outline, and/or contour of the object 316. Referring again to FIG. 5C, the ROI adjustment engine 306 can adjust the fixed ROI 504 based on the size and/or shape of the faces within the fixed ROI 504, thereby generating the adjusted ROIs 508. Further, if the object detection engine 304 detects that the image frame 312 includes one or more objects within a plurality of ROIs (at step 604), the ROI adjustment engine 306 can adjust one or more of the plurality of ROIs based on the objects within the plurality of ROIs.

In some cases, the ROI adjustment engine 306 can display (e.g., within the image frame 312) a visual graphic indicating the adjusted ROI. The visual graphic can correspond to the shape, size, and/or outline of the adjusted ROI. In one example, the ROI adjustment engine 306 can detect an additional user input associated with the visual graphic. The additional user input can indicate at least one additional adjustment to the adjusted ROI. Referring to FIG. 5E, the ROI adjustment engine 306 can detect user input associated with increasing the size of a portion of the adjusted ROIs 508 (e.g., resulting in the additional ROI 512). In some examples, the ROI adjustment engine 306 can determine a plurality of candidate adjusted ROIs corresponding to different adjustments to the predetermined size and/or the predetermined shape of the ROI. Each candidate adjusted ROI can correspond to a potential adjusted ROI that can be evaluated (e.g., by the user and/or by the ROI adjustment engine 306). In one example, the ROI adjustment engine 306 can sequentially display, within the image frame 312, a plurality of visual graphics corresponding to the plurality of candidate adjusted ROIs. The ROI adjustment engine 306 can determine a selection of one candidate adjusted ROI of the plurality of candidate adjusted ROIs based on detecting an additional user input associated with a visual graphic of the plurality of visual graphics corresponding to the one candidate adjusted ROI. For instance, the ROI adjustment engine 306 can detect user input selecting (e.g., clicking on, touching, verbally acknowledging, etc.) the particular visual graphic while the particular visual graphic is displayed within the image frame 312.

At step 608, the process 600 includes performing the one or more image capture operations on image data within the adjusted ROI. For instance, the image processing engine 308 can perform one or more image capture operations on image data within the adjusted ROI of the image frame 312. The adjusted ROI can correspond to an adjusted ROI determined by the ROI adjustment engine 306, an adjusted ROI that reflects additional adjustments indicated by the user, and/or an adjusted ROI selected from a plurality of candidate adjusted ROIs. In some examples, the image processing engine 308 can perform one or more “3A” operations (e.g., an auto-focus operation). The one or more image processing operations can be applied to image data within the adjusted ROI (and not applied to image data outside the adjusted ROI). For instance, the image processing engine 308 can apply one or more image processing operations to image data within the adjusted ROIs 508 of FIG. 5C. The image data portion 510 of FIG. 5D illustrates the image data within the adjusted ROIs 508 after the image processing engine 308 performs an auto-focus operation on the image data. By performing image processing operations only on image data within adjusted ROIs, the image processing and capture system 300 can accurately and efficiently produce high-quality and user-customizable images.

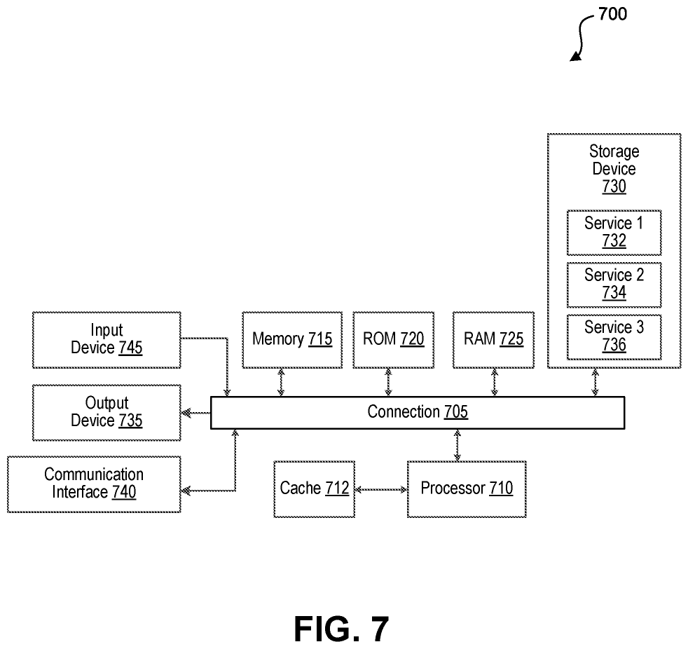

In some examples, the processes described herein (e.g., process 400, process 600 and/or other process described herein) may be performed by a computing device or apparatus (e.g., the device 322 shown in FIG. 3B). In one example, the process 400 and/or the process 600 can be performed by the image processing and capture system 300 of FIG. 3A and FIG. 3B. In another example, the process 400 and/or the process 600 can be performed by a computing device with the computing system 700 shown in FIG. 7. For instance, a computing device with the computing architecture shown in FIG. 7 can include the components of the image processing and capture system 300 and can implement the operations of FIG. 4 and FIG. 6.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 800. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 400 and the process 600 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 400, the process 600, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processyu76ytor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Aspect 1: A method of improving one or more image processing operations in image frames. The method includes: detecting a user input corresponding to a selection of a location within an image frame; determining that the image frame includes an object at least partially within a region of interest of the image frame, the region of interest including the selected location and having a predetermined size or a predetermined shape; adjusting the region of interest based at least in part on the determination; and performing the one or more image processing operations on image data within the adjusted region of interest.

Aspect 2: A method according to Aspect 1, further comprising receiving the image frame within a preview stream of frames including image frames captured by a camera device while the camera device is in an image capture mode.

Aspect 3: A method according to any of Aspects 1 or 2, wherein determining that the image frame includes the object at least partially within the region of interest of the image frame includes performing an object detection algorithm within the region of interest of the image frame.

Aspect 4: A method according to Aspect 3, wherein adjusting the predetermined size or the predetermined shape of the region of interest includes adjusting the predetermined shape of the region of interest based on the object detection algorithm.

Aspect 5: A method according to Aspect 4, wherein adjusting the predetermined shape of the region of interest based on the object detection algorithm includes determining a bounding box for the object based on the object detection algorithm; and setting the region of interest as the bounding box.

Aspect 6: A method according to any of Aspects 1 to 5, wherein adjusting the predetermine size or shape of the region of interest includes decreasing the predetermined size of the region of interest along at least one axis.

Aspect 7: A method according to any of Aspects 1 to 6, wherein adjusting the predetermined shape or size of the region of interest includes increasing the predetermined size of the region of interest along at least one axis.

Aspect 8: A method according to any of Aspects 1 to 7, wherein adjusting the predetermined size or the predetermined shape of the region of interest includes decreasing a distance between a boundary of the region of interest and a boundary of the one or more objects.

Aspect 9: A method according to Aspect 8, wherein decreasing the distance between the boundary of the region of interest and the boundary of the one or more objects includes determining a contour of an object within the image frame; and setting the boundary of the region of interest as the contour of the object within the image frame.

Aspect 10: A method according to Aspect 9, wherein determining the contour of the object within the image frame includes determining pixels corresponding to the contour within the image frame.

Aspect 11: A method according to any of Aspects 1 to 10, wherein determining that the image frame includes the object at least partially within the region of interest includes determining that the image frame includes one or more objects at least partially within a plurality of regions of interest within the image frame; and adjusting the predetermined size or the predetermined shape of the region of interest includes adjusting a predetermined size or the predetermined shape of the plurality of regions of interest.

Aspect 12: A method according to any of Aspects 1 to 11, further comprising overlaying, within the image frame, a visual graphic indicating the adjusted region of interest.

Aspect 13: A method according to Aspect 12, further comprising detecting an additional user input associated with the visual graphic, the additional user input indicating at least one additional adjustment to the adjusted region of interest.

Aspect 14: A method according to any of Aspects 1 to 13, further comprising determining a plurality of candidate adjusted regions of interest corresponding to different adjustments to the predetermined size or the predetermined shape of the region of interest; sequentially displaying, within the image frame, a plurality of visual graphics corresponding to the plurality of candidate adjusted regions of interest; and determining a selection of one candidate adjusted region of interest of the plurality of candidate adjusted regions of interest based on detecting an additional user input associated with a visual graphic of the plurality of visual graphics corresponding to the one candidate adjusted region of interest.

Aspect 15: A method according to any of Aspects 1 to 14, wherein the one or more image processing operations include an auto-focus operation.

Aspect 16: A method according to any of Aspects 1 to 15, wherein the one or more image processing operations include an auto-exposure operation.

Aspect 17: A method according to any of Aspects 1 to 16, wherein the one or more image processing operations include an auto-white-balance operation.

Aspect 18: A method according to any of Aspects 1 to 17, further comprising displaying the image frame on a display after performing the one or more image processing operations on the image data within the adjusted region of interest.

Aspect 19: An apparatus for improving one or more image processing operations in image frames. The apparatus includes a memory and a processor configured to: detect a user input corresponding to a selection of a location within an image frame; determine that the image frame includes an object at least partially within a region of interest of the image frame, the region of interest including the selected location and having a predetermined size or a predetermined shape; adjust the predetermined size or the predetermined shape of the region of interest based at least in part on the determination; and perform the one or more image capture operations on image data within the adjusted region of interest.

Aspect 20: An apparatus according to Aspect 19, wherein the processor is configured to receive the image frame within a preview stream of frames including image frames captured by a camera device while the camera device is in an image capture mode.

Aspect 21: An apparatus according to any of Aspects 19 or 20, wherein the processor is configured to determine that the image frame includes the object at least partially within the region of interest of the image frame based on performing an object detection algorithm within the region of interest of the image frame.

Aspect 22: An apparatus according to Aspect 21, wherein the processor is configured to determine a bounding box for the object based on the object detection algorithm; and setting the region of interest as the bounding box.

Aspect 23: An apparatus according to any of Aspects 19 to 22, wherein the processor is configured to decrease the predetermined size of the region of interest along at least one axis.

Aspect 24: An apparatus according to any of Aspects 19 to 23, wherein the processor is configured to increase the predetermined size of the region of interest along at least one axis.

Aspect 25: An apparatus according to any of Aspects 19 to 24, wherein the processor is configured to decrease a distance between a boundary of the region of interest and a boundary of the object.

Aspect 26: An apparatus according to Aspect 25, wherein the processor is configured to: determine a contour of an object within the image frame; and set the boundary of the region of interest as the contour of the object within the image frame.

Aspect 27: An apparatus according to Aspect 26, wherein the processor is configured to determine pixels corresponding to the contour within the image frame.

Aspect 28: An apparatus according any of Aspects 19 to 27, wherein the processor is configured to determine that the image frame includes the object at least partially within the region of interest based on determining that the image frame includes one or more objects at least partially within a plurality of regions of interest within the image frame; and adjust the predetermined size or the predetermined shape of the region of interest at least in part by adjusting the predetermined size or the predetermined shape of the plurality of regions of interest.

Aspect 29: An apparatus according to any of Aspects 19 to 28, wherein the processor is further configured to overlay, within the image frame, a visual graphic indicating the adjusted region of interest.

Aspect 30: An apparatus according to Aspect 29, wherein the processor is further configured to detect an additional user input associated with the visual graphic, the additional user input indicating at least one additional adjustment to the adjusted region of interest.

Aspect 31: An apparatus according to any of Aspects 19 to 30, wherein the processor is further configured to: determine a plurality of candidate adjusted regions of interest corresponding to different adjustments to the predetermined size or the predetermined shape of the region of interest; sequentially display, within the image frame, a plurality of visual graphics corresponding to the plurality of candidate adjusted regions of interest; and determine a selection of one candidate adjusted region of interest of the plurality of candidate adjusted regions of interest based on detecting an additional user input associated with a visual graphic of the plurality of visual graphics corresponding to the one candidate adjusted region of interest.

Aspect 32: An apparatus according to any of Aspects 19 to 31, wherein the one or more image capture operations include an auto-focus operation.

Aspect 33: An apparatus according to any of Aspects 19 to 32, wherein the one or more image capture operations include an auto-exposure operation.

Aspect 34: An apparatus according to any of Aspects 19 to 33, wherein the one or more image capture operations include an auto-white-balance operation.

Aspect 35: An apparatus according to any of Aspects 19 to 34, further comprising a display, wherein the processor is configured to display the image frame in the display after performing the one or more image capture on the image data within the adjusted region of interest.

Aspect 36: An apparatus according to any of Aspects 19 to 35, wherein the apparatus comprises a mobile device.

Aspect 37: An apparatus according to any of Aspects 19 to 36, wherein the apparatus comprises a camera device.

Aspect 38: A non-transitory computer-readable storage medium for improving one or more image processing operations in image frames. The non-transitory computer-readable storage medium includes instructions stored therein which, when executed by one or more processors, cause the one or more processors to perform any of the operations of Aspects 1 to 18. For example, the non-transitory computer-readable storage medium can include instructions stored therein which, when executed by one or more processors, cause the one or more processors to detect a user input corresponding to a selection of a location within an image frame; determine that the image frame includes an object at least partially within a region of interest of the image frame, the region of interest including the selected location and having a predetermined size or a predetermined shape; adjust the predetermined size or the predetermined shape of the region of interest based at least in part on the determination; and perform the one or more image processing operations on image data within the adjusted region of interest.

Aspect 39: A non-transitory computer-readable storage medium according to Aspect 38, wherein determining that the image frame includes the object at least partially within the region of interest of the image frame includes performing an object detection algorithm within the region of interest of the image frame.

Aspect 40: A non-transitory computer-readable storage medium according to any of Aspects 38 or 39, wherein adjusting the predetermined size or the predetermined shape of the region of interest includes decreasing a distance between a boundary of the region of interest and a boundary of the object.

Aspect 41: An image capture and processing system including one or more means for performing any of the operations of Aspects 1 to 18.

What is claimed is:

1. A method for improving one or more image capture operations in image frames, the method comprising:
detecting a user input corresponding to a selection of a location within an image frame;
determining that the image frame includes an object at least partially within a region of interest of the image frame, the region of interest including the selected location and having a predetermined size or a predetermined shape;
adjusting the predetermined size or the predetermined shape of the region of interest based at least in part on the determination; and
performing the one or more image capture operations on image data within the adjusted region of interest.

2. The method of claim 1, further comprising receiving the image frame within a preview stream of frames including image frames captured by a camera device while the camera device is in an image capture mode.

3. The method of claim 1, wherein determining that the image frame includes an object at least partially within the region of interest of the image frame includes performing an object detection algorithm within the region of interest.

4. The method of claim 3, wherein adjusting the predetermined size or the predetermined shape of the region of interest includes adjusting the predetermined shape of the region of interest based on the object detection algorithm.

5. The method of claim 4, wherein adjusting the predetermined shape of the region of interest based on the object detection algorithm includes:
determining a bounding box for the object based on the object detection algorithm; and
setting the region of interest as the bounding box.

6. The method of claim 1, wherein adjusting the predetermined size or the predetermined shape of the region of interest includes decreasing the predetermined size of the region of interest along at least one axis.

7. The method of claim 1, wherein adjusting the predetermined size or the predetermined shape of the region of interest includes increasing the predetermined size of the region of interest along at least one axis.

8. The method of claim 1, wherein adjusting the predetermined size or the predetermined shape of the region of interest includes decreasing a distance between a boundary of the region of interest and a boundary of the object.

9. The method of claim 8, wherein decreasing the distance between the boundary of the region of interest and the boundary of the object:
determining a contour of an object within the image frame; and
setting the boundary of the region of interest as the contour of the object within the image frame.

10. The method of claim 9, wherein determining the contour of the object within the image frame includes determining pixels corresponding to the contour within the image frame.

11. The method of claim 1, wherein:
determining that the image frame includes the object at least partially within the region of interest includes determining that the image frame includes one or more objects at least partially within a plurality of regions of interest within the image frame; and
adjusting the predetermined size or the predetermined shape of the region of interest includes adjusting a predetermined size or the predetermined shape of the plurality of regions of interest.

12. The method of claim 1, further comprising overlaying, within the image frame, a visual graphic indicating the adjusted region of interest.

13. The method of claim 12, further comprising detecting an additional user input associated with the visual graphic, the additional user input indicating at least one additional adjustment to the adjusted region of interest.

14. The method of claim 1, further comprising:
determining a plurality of candidate adjusted regions of interest corresponding to different adjustments to the predetermined size or the predetermined shape of the region of interest;
sequentially displaying, within the image frame, a plurality of visual graphics corresponding to the plurality of candidate adjusted regions of interest; and
determining a selection of one candidate adjusted region of interest of the plurality of candidate adjusted regions of interest based on detecting an additional user input associated with a visual graphic of the plurality of visual graphics corresponding to the one candidate adjusted region of interest.

15. The method of claim 1, wherein the one or more image capture operations include an auto-focus operation.

16. The method of claim 1, wherein the one or more image capture operations include an auto-exposure operation.

17. The method of claim 1, wherein the one or more image capture operations include an auto-white-balance operation.

18. The method of claim 1, further comprising displaying the image frame on a display after performing the one or more image capture operations on the image data within the adjusted region of interest.

19. An apparatus for improving one or more image capture operations in image frames, the apparatus comprising:
a memory:
a processor configured to:
detect a user input corresponding to a selection of a location within an image frame;
determine that the image frame includes an object at least partially within a region of interest of the image frame, the region of interest including the selected location and having a predetermined size or a predetermined shape;
adjust the predetermined size or the predetermined shape of the region of interest based at least in part on the determination; and
perform the one or more image capture operations on image data within the adjusted region of interest.

20. The apparatus of claim 19, wherein the processor is further configured to receive the image frame within a preview stream of frames including image frames captured by a camera device while the camera device is in an image capture mode.

21. The apparatus of claim 20, wherein the processor is configured to determine that the image frame includes the object at least partially within the region of interest of the image frame based on performing an object detection algorithm within the region of interest of the image frame.

22. The apparatus of claim 21, wherein the processor is configured to:
determine a bounding box for the object based on the object detection algorithm; and
set the region of interest as the bounding box.

23. The apparatus of claim 19, wherein the processor is configured to decrease the predetermined size of the region of interest along at least one axis.

24. The apparatus of claim 19, wherein the processor is configured to increase the predetermined size of the region of interest along at least one axis.

25. The apparatus of claim 19, wherein the processor is configured to decrease a distance between a boundary of the region of interest and a boundary of the object.

26. The apparatus of claim 25, wherein the processor is configured to:
determine a contour of an object within the image frame; and
set the boundary of the region of interest as the contour of the object within the image frame.

27. The apparatus of claim 26, wherein the processor is configured to determine pixels corresponding to the contour within the image frame.

28. The apparatus of claim 19, wherein the processor is configured to:
determine that the image frame includes the object at least partially within the region of interest based on determining that the image frame includes one or more objects at least partially within a plurality of regions of interest within the image frame; and
adjust the predetermined size or the predetermined shape of the region of interest at least in part by adjusting a predetermined size or the predetermined shape of the plurality of regions of interest.

29. The apparatus of claim 19, wherein the processor is configured to overlay, within the image frame, a visual graphic indicating the adjusted region of interest.

30. The apparatus of claim 29, wherein the processor is further configured to detect an additional user input associated with the visual graphic, the additional user input indicating at least one additional adjustment to the adjusted region of interest.

31. The apparatus of claim 19, wherein the processor is further configured to:
determine a plurality of candidate adjusted regions of interest corresponding to different adjustments to the predetermined size or the predetermined shape of the region of interest;
sequentially display, within the image frame, a plurality of visual graphics corresponding to the plurality of candidate adjusted regions of interest; and
determine a selection of one candidate adjusted region of interest of the plurality of candidate adjusted regions of interest based on detecting an additional user input associated with a visual graphic of the plurality of visual graphics corresponding to the one candidate adjusted region of interest.

32. The apparatus of claim 19, wherein the one or more image capture operations include an auto-focus operation.

33. The apparatus of claim 19, wherein the one or more image capture operations include an auto-exposure operation.

34. The apparatus of claim 19, wherein the one or more image capture operations include an auto-white-balance operation.

35. The apparatus of claim 19, further comprising a display, wherein the processor is configured to display the image frame on the display after performing the one or more image capture on the image data within the adjusted region of interest.

36. The apparatus of claim 19, wherein the apparatus comprises a mobile device.

37. The apparatus of claim 19, wherein the apparatus comprises a camera device.

38. A non-transitory computer-readable storage medium comprising instructions stored thereon which, when executed by one or more processors, cause the one or more processors to:
detect a user input corresponding to a selection of a location within an image frame;
determine that the image frame includes an object at least partially within a region of interest of the image frame, the region of interest including the selected location and having a predetermined size or a predetermined shape;
adjust the predetermined size or the predetermined shape of the region of interest based at least in part on the determination; and
perform one or more image capture operations on image data within the adjusted region of interest.

39. The non-transitory computer-readable storage medium of claim 38, wherein determining that the image frame includes the object within the region of interest of the image frame includes performing an object detection algorithm within the region of interest of the image frame.

40. The non-transitory computer-readable storage medium of claim 38, wherein adjusting the predetermined size or the predetermined shape of the region of interest includes decreasing a distance between a boundary of the region of interest and a boundary of the object.
